(19) United States
(12) Patent Application Publication
(10) Pub. No.: US 2010/0122083 A1
(43) Pub. Date: May 13, 2010

(54) METHOD AND APPARATUS FOR SECURELY COMMUNICATING PERSONAL HEALTH INFORMATION

(75) Inventors: Byung-soo Gim, Yongin-si (KR); Kwang-hyeon Lee, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/613,040

(22) Filed: Nov. 5, 2009

(30) Foreign Application Priority Data
Nov. 10, 2008 (KR) 10-2008-0111217

(51) Int. Cl. H04L 9/08; H04L 9/00

(52) U.S. Cl. 713/162; 713/150; 380/279; 380/278

(57) ABSTRACT

A method of securely communicating personal health information between a user terminal and a health care server. The method includes receiving an encryption key from a security key issuing device through a local communication between a user terminal and the security key issuing device; obtaining health information of a user; encrypting the health information by using the encryption key; and transmitting the encrypted health information to a health care server through a network communication between the user terminal and the health care server.

### CROSS-REFERENCE TO RELATED APPLICATIONS

This application claims priority to Korean Patent Application No. 10-2008-0111217, filed on Nov. 10, 2008, and all the benefits accruing therefrom under 35 U.S.C. §119, the content of which in its entirety is herein incorporated by reference.

### BACKGROUND

1. Field

One or more embodiments relate to a method and apparatus for securely communicating personal health information.

2. Description of the Related Art

At present, research is being actively conducted to establish a remote medical system for providing medical information and medical service to remote locations, and to provide a remote health monitoring service. In a remote medical service, a key factor is safe transmission of a user's health information. In the U.S., the government has enacted the Health Insurance Portability and Accountability Act (“HIPAA”) to ensure the security of personal health information. Public key cryptography and secret key cryptography are cryptographic systems currently used for secure communication. In these cryptographic systems, issuance of an initial encryption key and an initial decryption key is performed through the Internet.

### SUMMARY

Provided are a method and apparatus for secure communication, in which an encryption key and a decryption key are safely distributed and a user's health information is safely transmitted and received.

Provided are a computer-readable recording medium having recorded thereon a program for executing the method on a computer.

Additional aspects will be set forth in part in the description which follows and, in part, will be apparent from the description, or may be learned by practice of the invention.

Provided is a method of securely communicating between a user terminal and a health care server. The method includes receiving an encryption key from a security key issuing device through a local communication between a user terminal and the security key issuing device, obtaining health information of a user, encrypting the health information by using the encryption key, and transmitting the encrypted health information to a health care server through a network communication between the user terminal and the health care server.

Provided is a method of securely communicating between a health care server and a user terminal. The method includes receiving a decryption key from a security key issuing device through a local communication between a health care server and the security key issuing device, receiving encrypted information through a network communication between the health care server and a user terminal, and decrypting the encrypted information by using the decryption key.

Provided is a method of securely communicating between a user terminal and a health care server. The method includes transmitting an encryption key and a decryption key, which are issued by a security key issuing device to a user terminal and a health care server, encrypting health information of a user by using the encryption key, wherein the encrypting is performed in the user terminal, adding a unique identifier of the user to the encrypted health information; transmitting the unique identifier to the health care server through a network communication, decrypting the unique identifier by using the decryption key, wherein the decrypting is performed in the health care server; and recognizing personal information of the user by using the unique identifier.

Provided is a computer-readable recording medium having recorded thereon a program for executing a method of securely communicating personal health information.

Provided is a user terminal, including a health information obtaining unit for obtaining health information of a user, a local communicating unit, which receives an encryption key through a local communication between a user terminal and a security key issuing device, a security key obtaining unit, which obtains the encryption key, an encrypting unit, which encrypts the health information by using the encryption key, and a network communicating unit, which transmits the encrypted health information to a health care server through a network communication.

Provided is a health care server system including a local communicating unit, which receives a decryption key through a local communication between a health care server and a security key issuing device, a security key obtaining unit, which obtains the decryption key, a network communicating unit, which receives encrypted information from a user terminal through a network communication, and a decrypting unit, which decrypts the encrypted information by using the decryption key.

Provided is a security key issuing device for secure communication between a user terminal and a health care server. The security key issuing device includes a security key issuing unit, which issues at least one of an encryption key and a decryption key in response to a request from a healthcare service provider or a user, a security key storage unit, which stores the encryption key and the decryption key together with user information of a user terminal, and a security key transmitting unit, which transmits the encryption key and the decryption key to the user terminal and a health care server through a local communication.

### BRIEF DESCRIPTION OF THE DRAWINGS

These and/or other aspects will become apparent and more readily appreciated from the following further description of the embodiments, taken in conjunction with the accompanying drawings in which:

FIG. 1 is a flowchart illustrating an exemplary embodiment of a secure communication environment for personal health information;

FIG. 2 is a flowchart illustrating an exemplary embodiment of a structure of a secure communication system for personal health information;

FIG. 3 is a flowchart illustrating an exemplary embodiment of a data flow in a security managing unit of a user terminal, which is illustrated in FIG. 2, when public key cryptography is used;

FIG. 4 is a flowchart illustrating an exemplary embodiment of a data flow in the security managing unit of the user terminal illustrated in FIG. 2 when secret key cryptography is used;

FIG. 5 is a flowchart illustrating an exemplary embodiment of mapping tables of a storage unit illustrated in FIG. 2;

FIG. 6 is a flowchart illustrating an exemplary embodiment of a data flow in secure communication of the user terminal with a health care server when public key cryptography is used;

FIG. 7 is a flowchart illustrating an exemplary embodiment of a data flow in secure communication of the user terminal with the health care server when secret key cryptography is used;

FIG. 8 is a flowchart illustrating an exemplary embodiment of a method of analyzing a user's health information by an information analyzing unit;

FIG. 9 illustrates an exemplary embodiment of a data flow in security managing units, which use a reinforced version of a selected cryptographic system; and

FIG. 10 is a flowchart illustrating an exemplary embodiment of a method of securely communicating personal health information.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to further explain aspects of the present description.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The embodiments described herein should not be construed as limited to the particular shapes of regions as illustrated herein but are to include deviations in shapes. Thus, the regions illustrated in the figures are schematic in nature and their shapes are not intended to limit the scope of the present claims.

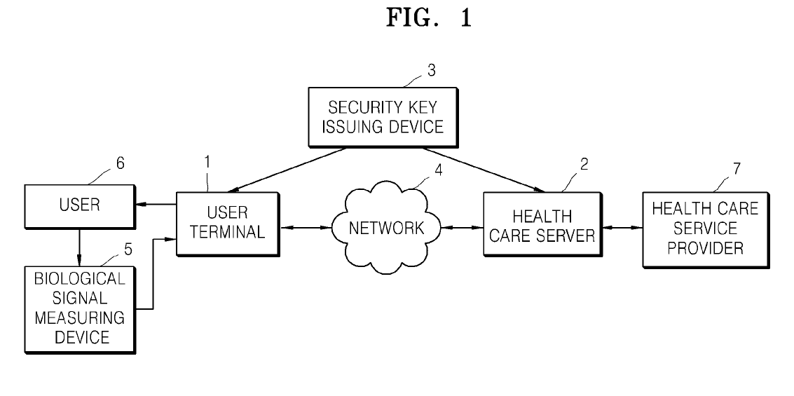

FIG. 1 is a flowchart illustrating an exemplary embodiment of a secure communication environment for personal health information. The secure communication environment for personal health information includes a user terminal 1, a health care server 2, a security key issuing device 3 and a biological signal measuring device 5. The security key issuing device 3 issues and then transmits an encryption key and a decryption key to the user terminal 1 and the health care server 2 through a local communication. A user 6 measures a health state by using the biological signal measuring device 5 and the user terminal 1 obtains health information of the user 6. The user terminal 1 and the health care server 2 communicate over a network 4, and the health information of the user 6 is transmitted in an encrypted state to maintain security. A healthcare service provider 7 recognizes the health information of the user 6 by using the health care server 2.

In an embodiment, the health care server 2 and the security key issuing device 3 are separate devices. In another embodiment the health care server 2 and the security key issuing device 3 may be integrated into one device. For example, functions of the security key issuing device 3 may be included into the health care server 2. In an embodiment, the biological signal measuring device 5 and the user terminal 1 are separate devices. In another embodiment, the biological signal measuring device 5 and the user terminal 1 may be integrated into one device. For example, functions of the user terminal 1 may be included in the biological signal measuring device 5.

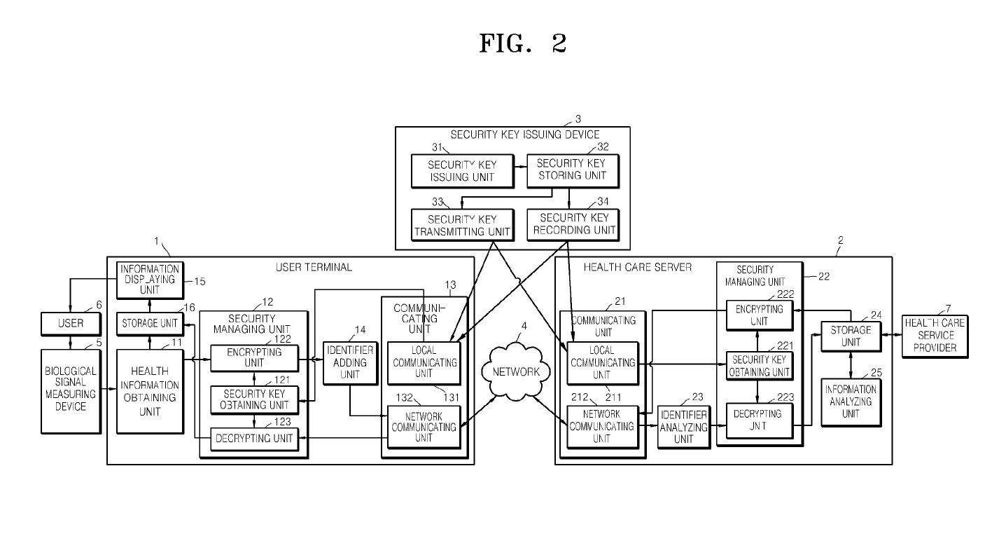

FIG. 2 is a flowchart illustrating an exemplary embodiment of a structure of a secure communication system for personal health information.

The biological signal measuring device 5 refers to a medical device and equipment for measuring a biological signal of the user 6. For example, the biological signal measuring device 5 may be an electroencephalograph, a brain wave analysis system, a retinal electrometer, a sphygmograph, a tocomonitor, a thermography, a slit lamp microscope, an anthropometer, a phonocardiograph, an electrocardiograph, a thermometer, a body weight scale, an ultrasonic blood flow meter, a hemadynamometer, a blood sugar monitor, a spirometer, or the like or a combination thereof. In an embodiment, the biological signal may be brain wave analysis data, an electromyogram, a body temperature, a blood pressure value, a body weight, an obesity index, a body fat mass, a liver value, a cholesterol value, a blood sugar value, or the like or a combination thereof. It will be understood by those of ordinary skill in the art that the biological signal, according to an embodiment, may include any value, state, or symptom related to health, and the biological signal measuring device 5 may include any device or equipment for recognizing the biological signal.

The user terminal 1 includes a health information obtaining unit 11, a security managing unit 12, a communicating unit 13, an identifier adding unit 14, an information displaying unit 15, and a storage unit 16.

The health information obtaining unit 11 obtains health information of the user 6 from the biological signal measuring device 5. The health information of the user 6 may be obtained in at least one of two ways: by input from the user 6 or by direct input based on the biological signal measuring device 5 and the user terminal 1. The way to obtain the health information of the user 6 may be selected by the user 6 or the healthcare service provider 7. For example, if the biological signal measuring device 5 is a thermometer, the health information obtaining unit 11 obtains body temperature information of the user 6, which is measured by the thermometer. In an embodiment, the obtaining of the body temperature information may be achieved by input of a body temperature measured by the thermometer from the user 6 or by direct input of the body temperature measured by the thermometer to the health information obtaining unit 11. The user terminal 1 may be linked to the biological signal measuring device 5 or may include a function of the biological signal measuring device 5.

The security managing unit 12 includes a security key obtaining unit 121, an encrypting unit 122 and a decrypting unit 123. The security key obtaining unit 121 obtains an encryption key and a decryption key issued by the security key issuing device 3. The encryption key is used to encrypt the health information of the user 6, and the decryption key is used to decrypt encrypted information transmitted from the healthcare service provider 7 or the health care server 2. For cryptographic systems executing encryption and decryption, public key cryptography and secret key cryptography may be used. Public key cryptography is also referred to as asymmetric cryptography or public key/private key cryptography. Secret key cryptography is also referred to as symmetric cryptography. According to a type of the cryptographic system, an encryption key may include at least one of a public key and a secret key and a decryption key may include at least one of a private key and a secret key. The type of cryptographic system may be selected according to a selection of the user 6 or the healthcare service provider 7 and a suitable encryption key and decryption key are obtained according to the selected type.

The security key obtaining unit 121 obtains an encryption key and a decryption key from a local communicating unit 131 or reads them from a portable storage medium. More specifically, if the encryption key and the decryption key are transmitted over a local network between the user terminal 1 and the security key issuing device 3, the security key obtaining unit 121 obtains the encryption key and the decryption key from the local communicating unit 131. If the encryption key and the decryption key are transmitted from the user 6 or the healthcare service provider 7 and stored in a portable storage medium, the security key obtaining unit 121 reads the encryption key and the decryption key stored in the portable storage medium. In an embodiment, the portable storage medium may include a computer-readable recording medium, which is portable. Examples of the computer-readable recording medium include magnetic storage media, e.g., read-only memory (“ROM”), a floppy disk, a hard disk and the like, and optical reading media, e.g., a compact disk read only memory (“CD-ROM”), a digital versatile disk (“DVD”) and the like.

More specifically, in an embodiment wherein a user 6 and a healthcare service provider 7 agree or express their intent, such as by way of a health-related contract or other exchange of promises, the healthcare service provider 7 issues and distributes an encryption key and a decryption key to the health care server 2 of the healthcare service provider 7 and the user terminal 1 to be delivered to the user 6 by using the security key issuing device 3. The distributed encryption key and decryption key are kept in a security key obtaining unit 121 of the user terminal 1 and a security key obtaining unit 221 of the health care server 2.

If the encryption key and the decryption key are transmitted while stored in a portable storage medium, at least one of an encryption key and a decryption key issued by a security key issuing unit 31 is recorded by a security key recording unit 34 onto the portable storage medium, which may be connected to the security key issuing device 3. The portable storage medium, while connected to the user terminal 1, may read a stored encryption key or a stored decryption key by using the local communicating unit 131 of the user terminal 1, and the security key obtaining unit 121 of the user terminal 1 may read the encryption key or the decryption key.

In an embodiment, a security key may be issued over a network, such as the Internet. A security problem may occur when the issued security key is distributed over the Internet. By using local communication, as in the foregoing embodiment, the security key can be safely distributed. Moreover, in an embodiment, information is transmitted between parties based on prior agreement of expressions of intention, such as a contract, making it possible to skip a separate authentication process.

It will be understood by those of ordinary skill in the art that a process of issuing and distributing an encryption key and a decryption key by the security key issuing device 3 and obtaining the encryption key and the decryption key by the security key obtaining unit 121 may be included in a process of manufacturing the user terminal 1 and the health care server 2.

The encrypting unit 122 encrypts health information obtained from the health information obtaining unit 11 by using an encryption key obtained from the security key obtaining unit 121 in a selected cryptographic system. In other words, by using the encryption key, the encrypting unit 122 converts the health information of the user 6 into a format in which the meaning of the health information cannot be determined without description. For example, the selected cryptographic system for executing encryption may be one of public key cryptography and secret key cryptography. When public key cryptography is used for encryption, the encryption key is a public key of a receiver, i.e., the health care server 2. When secret key cryptography is used for encryption, the encryption key is a secret key.

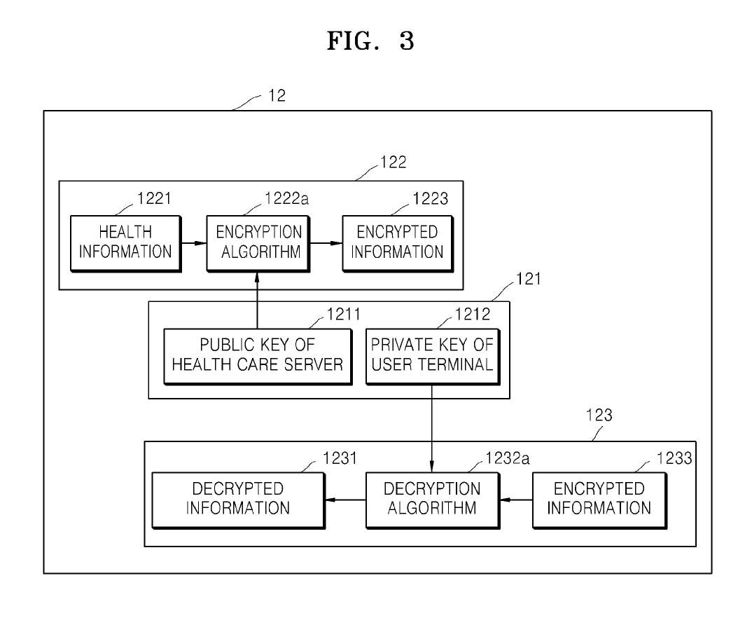

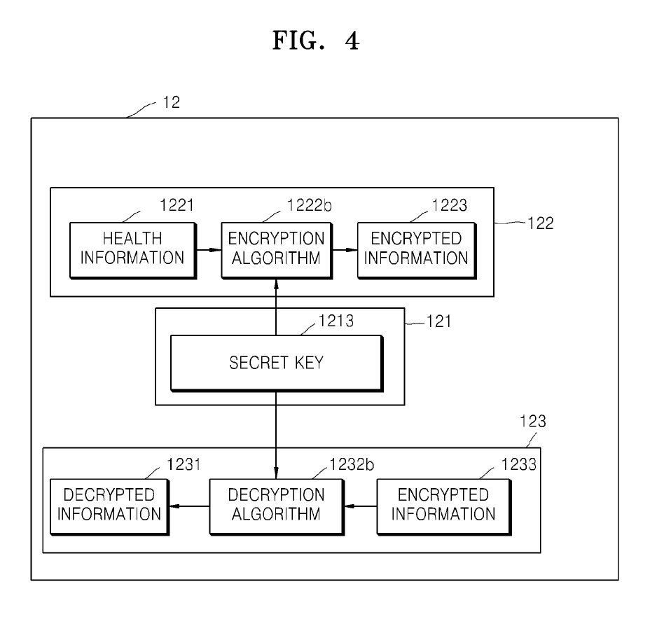

The decrypting unit 123 decrypts encrypted information obtained from the network communicating unit 132 by using a decryption key obtained from the security key obtaining unit 121 in the selected cryptographic system. In other words, the decrypting unit 123 restores the encrypted information transmitted from the health care server 2 to original information before decryption by using the decryption key. As mentioned above, when public key cryptography is used, the decryption key is a private key of the user terminal 1. When secret key cryptography is used, the decryption key is a secret key. FIGS. 3 and 4 are flow charts illustrating an exemplary embodiment of data flow in the first security managing unit 12, which is illustrated in FIG. 1.

FIG. 3 is a flowchart illustrating an exemplary embodiment of a data flow in the first security managing unit 12 of the user terminal 1, which is illustrated in FIG. 2, when public key cryptography is used. When information is transmitted from the user terminal 1 to the health care server 2, the encrypting unit 122 encrypts health information 1221 of the user 6 obtained from the health information obtaining unit 11 with an encryption algorithm 1222a, which uses a public key 1211 of the health care server 2 obtained by the security key obtaining unit 121. The health information 1221 of the user 6 is converted to encrypted information 1223 using the encryption algorithm 1222a.

The decrypting unit 123, when receiving information encrypted in the health care server 2, decrypts encrypted information 1233 obtained from the network communicating unit 132 with a decryption algorithm 1232a, which uses a private key 1212 of the user terminal 1 obtained by the security key obtaining unit 121. The encrypted information 1233 transmitted from the health care server 2 is restored to decrypted information 1231 using decryption algorithm 1232a, thereby restoring original information, which the health care server 2 transmits.

FIG. 4 is a flowchart illustrating an exemplary embodiment of a data flow in the first security managing unit 12 of the user terminal 1, which is illustrated in FIG. 2, when secret key cryptography is used. When information is transmitted from the user terminal 1 to the health care server 2, the encrypting unit 122 encrypts health information 1221 of the user 6 obtained from the health information obtaining unit 11 using an encryption algorithm 1222b, which uses a secret key 1213 of the security key obtaining unit 121. The health information 1221 of the user 6 is converted into encrypted information 1223 using the encryption algorithm 1222b.

The decrypting unit 123, after receiving information encrypted in the health care server 2, decrypts encrypted information 1233 obtained from the network communicating unit 132, with a decryption algorithm 1232b which uses a secret key 1213 of the security key obtaining unit 121. The encrypted information 1233 transmitted from the health care server 2 is restored to decrypted information 1231 using the third decryption algorithm 1232b, thereby restoring original information, which the health care server 2 transmits.

It will be understood by those of ordinary skill in the art that the encryption algorithm 1222a and the decryption algorithm 1232a are commercially available algorithms used in public key cryptography and the encryption algorithm 1222b and the decryption algorithm 1232b are commercially available algorithms used in secret key cryptography.

A security key, which hereinafter will collectively refer to an encryption key and a decryption key, is selected according to a type of selected cryptography system. In other words, when public key cryptography is used for encryption, the encryption key is a public key of the health care server 2 and the decryption key is a private key of the user terminal 1. When secret key cryptography is used for encryption, the encryption key and the decryption key are secret keys.

It will be also understood by those of ordinary skill in the art that in an embodiment, the encryption key may includes a document, a device, an instrument and a related technique, and may be used as a single unit for converting information into a format in which the meaning of the information cannot be determined without decryption, and the decryption key may include a document, a device, an instrument and a related technique, and may used as a single unit for restoring information, which has been converted into a format in which the meaning of the information cannot be determined without decryption, to original information. It will also be understood by those of ordinary skill in the art that in an embodiment the meaning of security management of the security managing unit 22 includes all functions, methods, and systems for protecting a communication network and system and application services from unauthorized access.

Referring to FIG. 2, the identifier adding unit 14 adds a unique identifier of the user terminal 1 to encrypted information being output from the encrypting unit 122. The identifier may be a symbol or a set of symbols used to indicate characteristics of the user terminal 1. The health care server 2 may be identified by the unique identifier of the user terminal 1 as the particular user terminal 1 among a plurality of health user terminals communicating with the health care server 2. For example, the identifier may include a symbol or a set of symbols, such as a device serial number of the user terminal 1, which is based on a contract made between the user 6 and the healthcare service provider 7.

For example, if the identifier of the user terminal 1 is 000, the identifier adding unit 14 adds the unique identifier 000 of the user terminal 1 to encrypted information encrypted by the encrypting unit 122 and transmits the addition result to the health care server 2 through the network communicating unit 132. During transmission of personal health information, encrypted health information and an identifier are transmitted, whereas a user's personal information is not transmitted. Thus, in spite of unauthorized receipt of user's health information during transmission, as may occur by hacking or hijacking, secure communication is possible in which high-level security is substantially guaranteed by protecting a user's privacy because user's personal information is not included in the transmitted personal health information.

The communicating unit 13 includes the local communicating unit 131 and the network communicating unit 132. The local communicating unit 131 transmits the encryption key and the decryption key issued by the security key issuing device 3 to the security key obtaining unit 121 of the user terminal 1 by using local communication. According to a selection of the user 6 or the healthcare service provider 7, the security key may be distributed to the security key obtaining unit 121 of the user terminal 1 by using a local network or by recording the security key onto a portable storage medium.

More specifically, the encryption key and the decryption key issued by the security key issuing unit 31 of the security key issuing device 3 are stored in a security key storage unit 32, together with personal information of the user 6. When a local network is used for transmission of the encryption key and the decryption key, the encryption key and the decryption key are transmitted by a security key transmitting unit 33 to the security key obtaining unit 121 through the local communicating unit 131. When a portable storage medium is used for transmission of the encryption key and the decryption key, the encryption key and the decryption key are recorded by the security key recording unit 34 onto the portable storage medium connected to the security key issuing device 3 and the encryption key and the decryption key stored in the portable storage medium are read by the local communicating unit 131 from the portable storage medium connected to the user terminal 1. The encryption key and decryption key are then transmitted to the security key obtaining unit 121. The portable storage medium includes any portable computer-readable recording medium. Examples of the computer-readable recording medium include magnetic storage media, e.g., ROM, a floppy disk, a hard disk and the like, and optical reading media, e.g., a CD-ROM, a DVD and the like.

It will be understood by those of ordinary skill in the art that a process of issuing the encryption key and the decryption key and transmitting them to the user terminal 1 and the health care server 2 by the security key issuing device 3 may be included in a process of manufacturing the user terminal 1 and the health care server 2.

As further mentioned above, since distribution of an encryption key and a decryption key is performed through local communication, a problem in security key distribution using the Internet, i.e., fraudulent use of a security key, can be substantially prevented or eliminated. Transmission of personal health information is generally performed based on a contract between the user 6 and the healthcare service provider 7 and the user terminal 1 does not use a web browser. In this regard, it may be difficult to apply a general communication security method to the transmission of the personal health information. Thus, by using the one of the foregoing embodiments, secure communication of personal health information can be performed. In addition, since the user terminal 1 interacts with the health care server 2, an encryption key and a decryption key are distributed by using local communication before delivery, transfer, or lending of the user terminal 1 to the user 6 occurs, thereby providing secure communication.

The network communicating unit 132 transmits a result of adding an identifier to information encrypted by the encrypting unit 122 by the identifier adding unit 14 to the health care server 2 through the network 4, or receives and outputs information transmitted from the health care server 2 to the decrypting unit 123. It will be understood by those of ordinary skill in the art that in an embodiment, the network 4 may be generally the Internet, but may also be another type of network such as a wireless local area network (“WLAN”).

The information displaying unit 15 displays a measurement result of a biological signal of the user 6 and information received from the health care server 2. The information displaying unit 15 may include a device for displaying visual information, e.g., a display, a liquid crystal display (“LCD”) screen, a light emitting diode (“LED”), a scale display device or the like and a device for displaying auditory information, e.g., a speaker or the like.

The storage unit 16 stores the measurement result of the biological signal of the user 6 and the information received from the health care server 2. Whether to store the measurement result and the received information is selected by a selection of the user 6. In other words, the user 6 may control the user terminal 1 to store desired information.

In an embodiment, the health care server 2 includes a communicating unit 21, a security managing unit 22, an identifier analyzing unit 23, a storage unit 24 and an information analyzing unit 25. The health care server 2 may be a server, which stores, analyzes and provides information related to the health of the user 6. In an embodiment, health care includes all actions to be made in pursuit of maintaining and promoting health and preventing disease.

The communicating unit 21 includes a local communicating unit 211 and a network communicating unit 212. The local communicating unit 211 transmits at least one of an encryption key and a decryption key issued by the security key issuing device 3 to the security key obtaining unit 221 of the health care server 2 through local communication. According to a selection of the user 6 or the healthcare service provider 7, a local network may be used, or an issued security key may be recorded onto a portable storage medium and then distributed to the security key obtaining unit 221 of the health care server 2 by using the portable storage medium. As disclosed further above, the portable storage medium may be a portable computer-readable recording medium. Examples of the computer-readable recording medium include magnetic storage media, e.g., ROM, a floppy disk, a hard disk and the like, and optical reading media, e.g., a CD-ROM, a DVD and the like.

The network communicating unit 212 outputs information received through the network 4 to a decrypting unit 223 through the identifier analyzing unit 23, or transmits information encrypted by an encrypting unit 222 to the user terminal 1 through the network 4. As mentioned previously, it will be understood by those of ordinary skill in the art that in the current embodiment, the network 4 may be generally the Internet, but may also be another type of network such as a wireless local area network (“WLAN”).

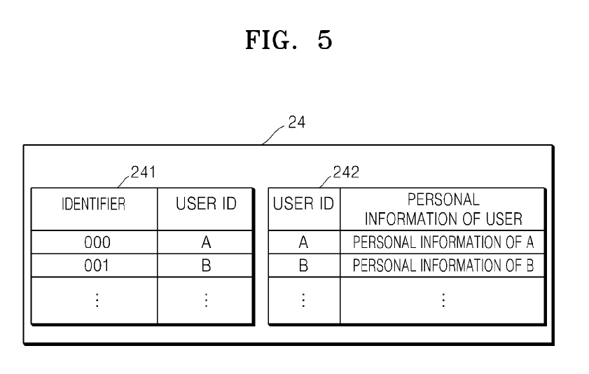

To analyze an identifier included in information received from the network communicating unit 212, the identifier analyzing unit 23 recognizes the user 6 of the user terminal 1 which transmits the information by referring to a mapping table 241 of the storage unit 24 and controls the security key obtaining unit 221 to use an encryption key and a decryption key that are previously agreed with the user terminal 1. FIG. 5 illustrates mapping tables of the storage unit 24 illustrated in FIG. 2.

For example, if an identifier of the user terminal 1 is 000, the information received from the network communicating unit 212 includes the identifier 000 and encrypted information. The identifier analyzing unit 23 recognizes that a user identification (“ID”) corresponding to the identifier 000 is a particular value, for example “A” in mapping table 1, by referring to a first mapping table 241. The identifier analyzing unit 23 also controls the security key obtaining unit 221 to use an encryption key and a decryption key that are previously agreed with the particular user, for example “A”.

Referring again to FIG. 2, the security managing unit 22 includes the security key obtaining unit 221, the encrypting unit 222, and the decrypting unit 223.

The security key obtaining unit 221 obtains an encryption key and a decryption key issued by the security key issuing device 3. The encryption key encrypts information to be transmitted to the user 6 and the decryption key decrypts encrypted information transmitted from the user 6. According to a type of a selected cryptographic system, as described further above in association with the user terminal 1, the encryption key includes at least one of a public key of the user terminal 1 and a secret key and the decryption key includes at least one of a private key of the health care server 2 and a secret key. A selected cryptographic system is selected by the user 6 or the healthcare service provider 7, and a suitable encryption key and decryption key are obtained according to the type of selected cryptographic system.

It will be understood by those of ordinary skill in the art that a process of issuing and distributing an encryption key and a decryption key by the security key issuing device 3 and obtaining the encryption key and the decryption key by the security key obtaining unit 221 may be included in a process of the health care server 2.

The encrypting unit 222 encrypts an analysis result of the health information of the user 6 obtained by the information analyzing unit 25 by using the encryption key obtained from the security key obtaining unit 221. By using a selected cryptographic system selected by the user 6 or the healthcare service provider 7, the encrypting unit 222 encrypts the analysis result of the health information stored in the storage unit 24.

The decrypting unit 223 restores information encrypted in the user terminal 1 to original information in a process that is substantially the reverse of an encryption process. The decrypting unit 223 receives encrypted information through the identifier analyzing unit 23 and obtains a decryption key from the security key obtaining unit 221. The decrypting unit 223 decrypts the encrypted information by using a decryption algorithm. Information encrypted in the encrypting unit 122 of the user terminal 1 is decrypted in the health care server 2, thereby reconstructing original information before encryption, i.e., the health information of the user 6. Information decrypted in the decrypting unit 223 of the health care server 2 is stored in the storage unit 24. The healthcare service provider 7 may determine a health state of the user 6 by referring to the health information of the user 6 stored in the storage unit 24.

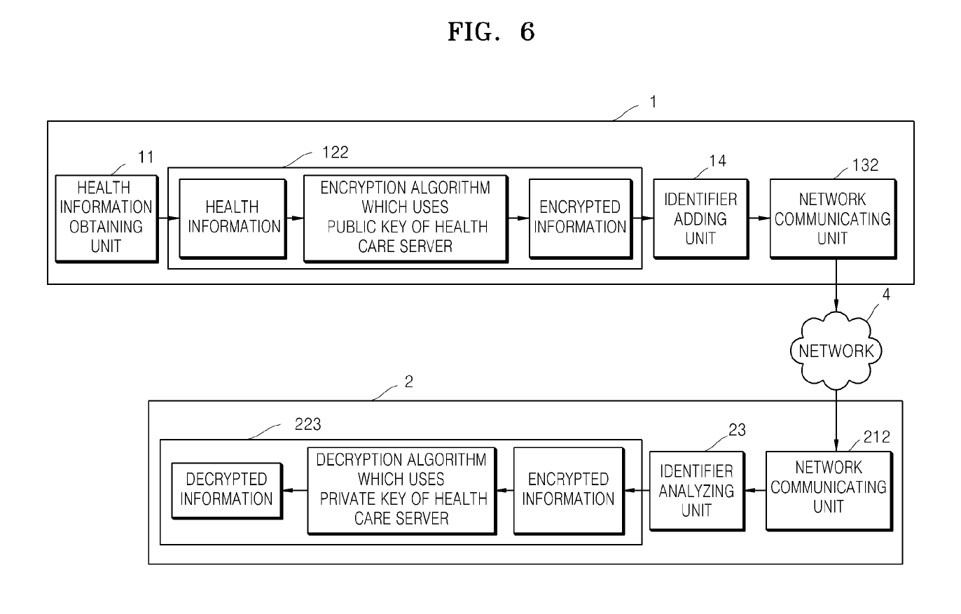

FIG. 6 is a flowchart illustrating an exemplary embodiment of a data flow during secure communication of the user terminal 1 with the health care server 2 when public key cryptography is used. The encrypting unit 122 obtains health information of the user 6 obtained by the health information obtaining unit 11 and encrypts the health information by using a public key of the health care server 2. The encrypted information, after passing through the identifier adding unit 14, is transmitted to the health care server 2 through the network 4. In the health care server 2, the encrypted information, after passing through the identifier analyzing unit 23, is decrypted by using a private key of the health care server 2. As a result of the decryption, the health information of the user 6 is reconstructed.

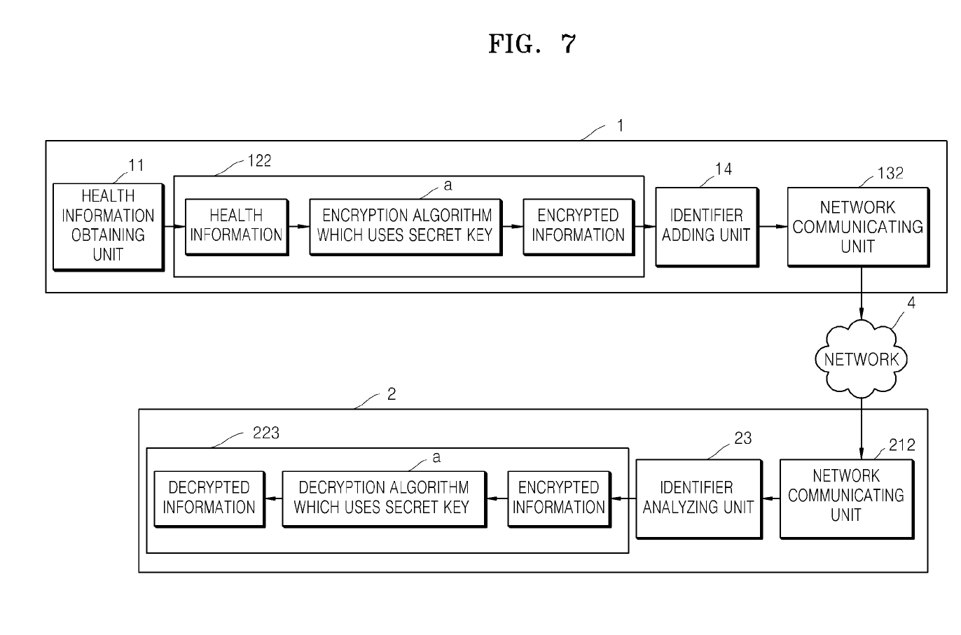

FIG. 7 is a flow chart illustrating an exemplary embodiment of a data flow during secure communication of the user terminal 1 with the health care server 2 when secret key cryptography is used. The data flow corresponds substantially to the data flow described in association with public key cryptography, except that the encryption and the decryption are performed using a secret key instead of the public key or the private key of the health care server 2, as indicated in FIG. 7.

The security key obtaining unit 221 of the health care server 2 keeps encryption keys and decryption keys of a plurality of user terminals, and thus selects an encryption key and a decryption key for encryption and decryption according to the above-described analysis result of the identifier analyzing unit 23.

As is further disclosed above, it will be understood by those of ordinary skill in the art that in an embodiment, the encryption key may include a document, a device, an instrument and a related technique, and may be used as a single unit for converting information into a format in which the meaning of the information cannot be determined without decryption, and the decryption key may include a document, a device, an instrument and a related technique, and may be used as a single unit for restoring information, which has been converted into a format in which the meaning of the original information cannot be determined without decryption. It will be also understood by those of ordinary skill in the art that in an embodiment, the meaning of security management of the second security managing unit 22 includes all functions, methods and systems for protecting a communication network, system and application services from unauthorized access.

The storage unit 24 stores health information of the user 6, which is decrypted information output from the decrypting unit 223, the analysis result of the health information of the user 6 obtained by the information analyzing unit 25 and mapping tables. Referring to FIG. 5, an ID of the user 6 can be determined using an identifier with reference to the first mapping table 241 and personal information including health records of the user 6 can be accessed using the ID of the user 6 with reference to a second mapping table 242. The healthcare service provider 7 may refer to health information of the user 6 through the storage unit 24 of the health care server 2. Since information transmitted from the user terminal 1 does not include personal information of the user 6, privacy and security for the user 6 are maintained in spite of the information loss during transmission over a network.

For example, if the identifier is 000 and the decrypted information is a body temperature, it is possible to determine that an ID of the user 6 is “A” by referring to the first mapping table. That is, it can be determined that the user terminal 1 of the user 6 having the ID “A” transmits a measurement result of the body temperature of the user 6 to the health care server 2. In addition, by referring to the second mapping table, personal information of the user, “A” in the foregoing example, can be determined. For example, the personal information of user “A” may be a name, an age or a previous health record of “A”.

The information analyzing unit 25 obtains the health information transmitted from the user terminal 1 from the storage unit 24, analyzes the measurement result of the biological signal and stores an analysis result in the storage unit 24. The analysis result, after encryption, transmission over the network 4 and decryption, as further described above, is transmitted to a device including at least one of the information displaying unit 15 of the user terminal 1 and an information receiving device of the user 6. A display method includes at least one of visual presentation on a display, a monitor, a light emitting display (“LED”) or the like and optionally auditory presentation by generation of a sound. The transmission includes a form of transmission performed by extended delivery media, except for the user terminal 1, such as an electronic mail (“E-mail”), cell phone text message transmission or a fax machine, for example.

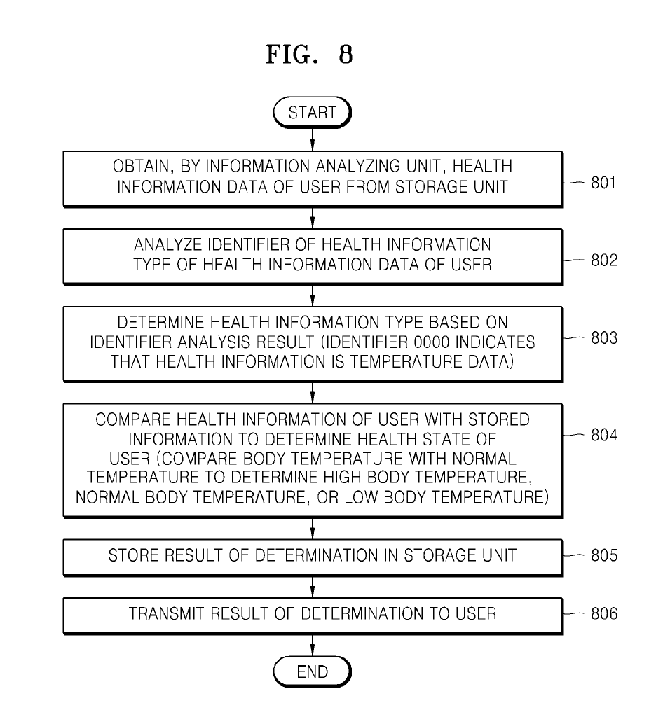

FIG. 8 is a flowchart illustrating analysis of health information of the user 6 by the information analyzing unit 25 according to an exemplary embodiment.

In first operation 801, the information analyzing unit 25 obtains health information data of the user 6 stored in the storage unit 24. The health information data of the user 6 includes an identifier for identifying a health information type and the health information, e.g., a measurement result of a biological signal.

In second operation 802, an identifier for the health information type is analyzed to determine the health information type. In an embodiment, for the determination, the health information type may be set to a digital value of 4 bits based on agreement between the user terminal 1 and the health care server 2. For example, an identifier for a health information type may be preset such that an identifier for a body temperature is 0000, an identifier for a weight is 0001, an identifier for a blood pressure value is 0002, and the like, for example, and the user terminal 1 transmits the identifier for the health information type through the health information in the form of a header file. The health care server 2 recognizes the health information type by using the identifier. However, a form of the identifier may also be a symbol or combination of symbols, or the like, without limitation to the foregoing embodiment.

In third operation 803, the information analyzing unit 25 determines the health information type. If the health information type of the user 6 is a body temperature, the information analyzing unit 25 determines that the health information is temperature data by referring to an identifier for the health information type, for example 0000 for the body temperature as further disclosed in the foregoing example.

In fourth operation 804, the information analyzing unit 25 compares the temperature data of the user 6 with a stored normal temperature. The information analyzing unit 25 determines a high body temperature when the temperature data is higher than the normal temperature, a normal body temperature when the temperature data is in a range of the normal temperature, and a low body temperature when the temperature data being lower than the normal temperature.

In fifth operation 805, the information analyzing unit 25 stores a result of the determination in the storage unit 24. The result stored in the storage unit 24 may be referred to by the healthcare service provider 7.

In sixth operation 806, the stored result may be received by at least one of the user terminal 1 and an information receiving device of the user 6, which is an extended delivery medium. For example, the information receiving device includes any device capable of receiving information through a network, such as an e-mail service, a cell phone text message service, a fax machine or the like. The transmission to the user terminal 1 includes all of encryption in the health care server 2, transmission through the network 4 and decryption in the user terminal 1.

Referring further to FIG. 2, under control of the user 6, the healthcare service provider 7, or an operator of the security key issuing device 3, the security key issuing device 3 issues an encryption key and a decryption key, stores the encryption key and the decryption key together with information of the user 6 and distributes the encryption key and the decryption key to the designated user terminal 1 and health care server 2. As further disclosed above, for the distribution of the encryption key and the decryption key, local communication may be used or the encryption key and the decryption key may be stored in a portable storage medium.

More specifically, the security key issuing device 3 includes the security key issuing unit 31, the security key storage unit 32, the security key transmitting unit 33 and the security key recording unit 34. The security key issuing unit 31 issues the encryption key and the decryption key in response to at least one of a request from the user 6 and the healthcare service provider 7. A selected cryptographic system is selected by the user 6 or the healthcare service provider 7, and a suitable security key is issued, stored and distributed as described above in association with the encryption. The security key is available in the designated user terminal 1 and health care server 2.

The security key storage unit 32 stores the issued encryption key and decryption key. Since, in an embodiment, the security key issuing device 3 issues encryption keys and decryption keys for a plurality of users, it may store an encryption key and a decryption key together with individual information of each of the users.

The encryption key and the decryption key are distributed by using at least one of the security key transmitting unit 33 and the security key recording unit 34. The user 6 or the healthcare service provider 7 may select a method for the distribution. The security key transmitting unit 33 transmits the issued encryption key and decryption key to the designated health care server 2 and user terminal 1 by using a local network. In the current embodiment, the local network directly connects the user terminal to the health care server 2. In this way, security of the encryption key and the decryption key can be maintained.

In an embodiment, the security key recording unit 34 records an encryption key and a decryption key onto a portable storage medium connected to the security key issuing device 3. The encryption key and the decryption key recorded onto the portable storage medium are transmitted by the user 6 and the healthcare service provider 7 to the security key obtaining unit 121 and the security key obtaining unit 221 through the local communicating unit 131 and local communicating unit 211 when the portable storage medium is connected to the user terminal 1 and the health care server 2. In an embodiment, the portable storage medium includes a portable computer-readable recording medium. Examples of the computer-readable recording medium include magnetic storage media, e.g., ROM, a floppy disk, a hard disk, and the like, and optical reading media, e.g., a CD-ROM, a DVDs, and the like.

As described above, distribution of the encryption key and the decryption key, which is a core part of secure communication, can be safely achieved. In other words, it is possible to substantially reduce or prevent hacking of the encryption key and the decryption key, which may occur during security key distribution through the Internet. Since the user terminal 1 is used as a device for transmitting health information of the user 6 rather than as a general-purpose medium and information transmission is performed based on agreement between the user 6 and the healthcare service provider 7, the security key distribution can be performed safely as disclosed above.

It will be understood by those of ordinary skill in the art that a process of issuing, storing, and transmitting a security key in an embodiment may be included in a process of manufacturing the user terminal 1 and the health care server 2.

The network 4 allows information to be exchanged between the user terminal 1 and the health care server 2. As mentioned previously, for example, the network 4 may be any one of a wired or wireless communication network, such as and including the Internet.

Since fraudulent use of a security key may be prevented by using the security key issuing device 3, safe transmission of personal health information is guaranteed even when an existing communication network is used. Information transmitted over the network 4 is encrypted information, and thus health information of the user 6 is not leaked in spite of hacking of the information. Moreover, the privacy of the user 6 is guaranteed because personal information of the user 6 is not included in the transmitted information.

Although the user terminal 1, the health care server 2, and the security key issuing device 3 illustrated in FIG. 2 may include other components for executing general functions, components related to the disclosed embodiment are illustrated in FIG. 2 for clarity and to avoid undue complexity.

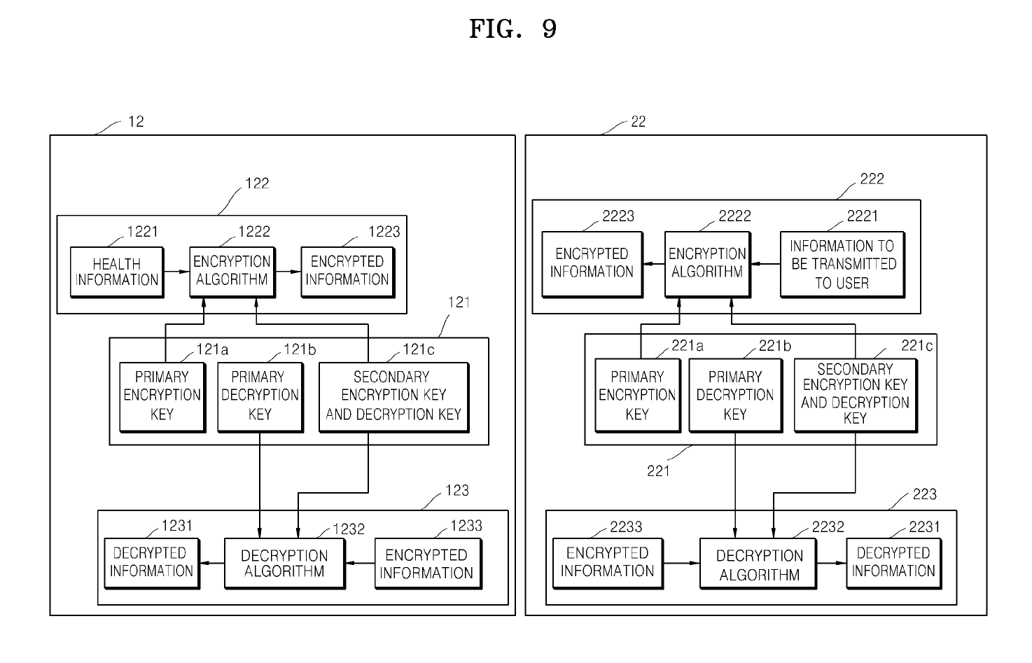

FIG. 9 is a flowchart illustrating an exemplary embodiment of a data flow in the security managing unit 12 and security managing unit 22, which use a reinforced version of a selected cryptographic system. Encryption and decryption processes higher than second order processes are carried out by using an Ethernet medium access control (“MAC”) address, thereby establishing a reinforced security system.

More specifically, during encryption, an encryption algorithm 1222 performs primary encryption by using a primary encryption key 121a and performs secondary encryption by using a first MAC address as a secondary encryption and decryption key 121c. The encrypted information 1223 is transmitted to the health care server 2, and during decryption in the health care server 2, a decryption algorithm 2232 performs primary decryption by using a primary decryption key 221b and performs secondary decryption by using a second MAC address as the secondary encryption and decryption key 221c, thereby reconstructing health information before encryption. In other words, by adding an encryption process higher than a second order process and a decryption process higher than a second order process to the encryption algorithm 1222 and the decryption algorithm 2232, respectively, the above-described functions can be executed. Similarly, transmitting an information from the health care server 22 to the user terminal 12 by using a reinforced version of the selected cryptographic system is available. It will be understood by those of ordinary skill in the art that when an encryption process higher than a first order process and a decryption process higher than a first order process are performed, the temporal sequence of encryption and decryption may vary regardless of the ranking of the order. According to an exemplary embodiment, second order encryption and second order decryption may use a MAC address of the health care server 2 or a MAC address of the user terminal 1. Moreover, according to another exemplary embodiment, an encryption process higher than a second order process and a decryption process higher than a second order process, using both the MAC address of the health care server 2 and the MAC address of the user terminal 1, may be added. A more detailed description will now be made of each of the embodiments.

When the MAC address of the health care server 2 is used, the health care server 2 transmits the MAC address of the health care server 2 to the security key obtaining unit 121 of the user terminal 1 by using local communication prior to an action such as transfer or delivery of the user terminal 1 to the user 6. In addition, the MAC address of the health care server 2 is recorded in the security key obtaining unit 221. The MAC address of the health care server 2 is used as a secondary encryption and decryption key 121c and as a secondary encryption and decryption key 221c. In other words, the MAC address of the health care server 2 is used as a secret key of secret key cryptography. In this way, by using the MAC address of the health care server 2, a reinforced security system can be established.

When the MAC address of the user terminal 1 is used, the MAC address of the user terminal 1 is transmitted to the security key obtaining unit 221 of the health care server 2 through a network after an action such as transferral or delivery of the user terminal 1 to the user 6. In addition, the MAC address of the user terminal 1 is recorded in the security key obtaining unit 121 of the user terminal 1. In other words, the MAC address of the user terminal 1 is used as a secret key of secret key cryptography. The MAC address of the user terminal is used as the secondary encryption and decryption key 121c and the secondary encryption and decryption key 221c. However, although there is a risk of fraudulent use of the MAC address of the user terminal 1 because a network, instead of local communication, has to be used, during transmission of the MAC address to the health care server 2, such transmission supplements existing first order encryption and decryption, thereby reinforcing existing security.

When both the MAC address of the user terminal 1 and the MAC address of the health care server 2 are used, various embodiments may exist. In other words, in an embodiment where an encryption process higher than a second order process and a decryption process higher than a second order process are performed by using both MAC addresses, an embodiment wherein the MAC address of the user terminal 1 is used as a public key and the MAC address of the health care server 2 is used as a private key, and an embodiment wherein the MAC address of the health care server 2 is used as a public key and the MAC address of the user terminal 1 is used as a private key. The selected cryptographic system can be reinforced by a selection of the user 6 or the healthcare service provider 7.

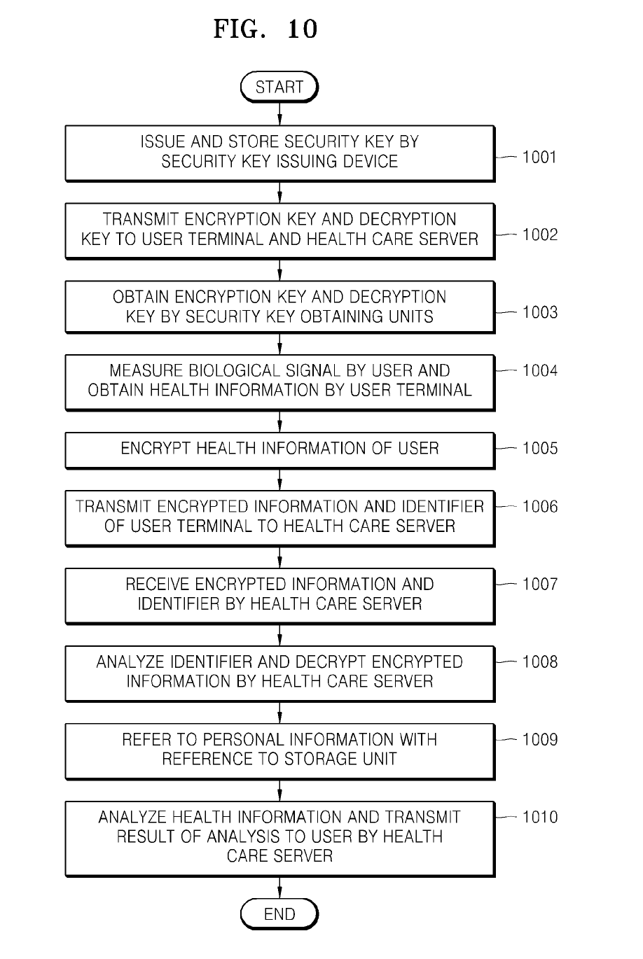

FIG. 10 is a flowchart illustrating an exemplary embodiment of a method of securely communicating personal health information. Referring to FIG. 10, the method of securely communicating personal health information according to an embodiment includes operations processed time-serially by the user terminal 1 and the health care server 2, as further illustrated in FIG. 2. Thus, the above description of the user terminal 1 and the health care server 2 is also applicable to the method of securely communicating personal health information according to n embodiment.

In an issuing and storing operation 1001, in the security key issuing device 3, an encryption key and a decryption key are issued by the security key issuing unit 31 and then stored in the security key storage unit 32. The security key storage unit 32 stores the issued security key together with information of the user 6 for which the security key is issued.

In a first transmitting operation 1002, the issued security key is transmitted by using at least one of the security key transmitting unit 33 and the security key recording unit 34 of the security key issuing device 3. A form of transmission includes at least one of transmission through a local network and a portable storage medium according to a selection of the user 6, the healthcare service provider 7 and an operator of the security key issuing device 3.

In an obtaining operation 1003, the security key obtaining unit 121 and the security key obtaining unit 221 of the user terminal 1 and the health care server 2 obtain the encryption key and the decryption key. In other words, the encryption key and the decryption key may be received from the security key transmitting unit 33 or may the security key recording unit 34. By using the obtained security key, the user terminal 1 and the health care server 2 can continuously perform encryption and decryption of information.

In a measuring operation 1004, the biological signal measuring device 5 measures a biological signal of the user 6. The health information obtaining unit 11 of the user terminal 1 obtains a measurement result of the biological signal. As previously mentioned, the measurement result may be obtained by input of the measurement result from the user 6 or by automatic input of the measurement result based on interaction between the biological signal measuring device 5 and the user terminal 1.

In an encrypting operation 1005, health information of the user 6, after passing through the health information obtaining unit 11 of the user terminal 1, is encrypted by the encrypting unit 122.

In a second transmitting operation 1006, encrypted information and an identifier added thereto by the identifier adding unit 14 are transmitted to the health care server 2 through the network communicating unit 132. The user terminal 1 may store an algorithm related to transmission in the storage unit 16. For example, the algorithm may select a transmission interval for the health information of the user 6, such as daily transmission, weekly transmission, monthly transmission or transmission each time a measurement is performed, according to a pattern of use by the user 6, thereby allowing the user 6 to easily and conveniently transmit the health information. The transmission may use an existing wired or wireless communication network. The transmission may also be performed by recording the health information onto a computer-readable recording medium by the user 6 and directly providing the recorded health information to the healthcare service provider 7.

In receiving operation 1007, the network communicating unit 212 of the health care server 2 receives the encrypted information and the identifier.

In analyzing operation 1008, the identifier analyzing unit 23 of the health care server 2 analyzes the received identifier and decrypts the encrypted information by using the decryption key of the security key obtaining unit 221.

In referring operation 1009, the health care server 2 stores the decrypted health information of the user 6 in the storage unit 24, searches for an ID of the user 6 corresponding to the identifier by referring to the first mapping table 241, and refers to personal information of the user 6 with reference to the second mapping table 242.

In second analyzing operation 1010, the health care server 2 analyzes the health information of the user 6 and transmits a result of the analysis to the user 6.

As is apparent from the foregoing description, personal health information can be safely communicated between the user terminal 1 and the health care server 2. An encryption key and a decryption key are transmitted by using local communication, thereby removing a risk of fraudulent use of the encryption key and the decryption key during distribution of the encryption key and the decryption key. Moreover, since the personal health information can be transmitted and received through the network 4, such transmission/reception can be performed efficiently and conveniently. Only encrypted information is communicated between the user terminal 1 and the health care server 2 and the encrypted information does not include personal information of the user 6, thereby substantially preventing or eliminating unwanted disclosure or leakage of personal health information.

In addition, other embodiments can also be implemented through computer readable code, instructions in and/or on a medium, e.g., a computer readable medium, to control at least one processing element to implement any above described embodiment. The medium can correspond to any medium/media permitting the storage and/or transmission of the computer readable code.

The computer readable code can be recorded/transferred on a medium in a variety of ways, and examples of the medium including recording media, such as magnetic storage media (e.g. ROM, a floppy disk, a hard disk or the like and optical recording media, (e.g. a CD-ROM or a DVD), and transmission media such as media carrying or including carrier waves, as well as elements of the Internet. Thus, the medium may be such a defined and measurable structure including or carrying a signal or information, such as a device carrying a bitstream according to one or more embodiments. The media may also be a distributed network, so that the computer readable code is stored/transferred and executed in a distributed fashion. Furthermore, the processing element could include a processor or a computer processor, and processing elements may be distributed and/or included in a single device.

As described above, according to the one or more of the above embodiments, health information of a user can be safely transmitted to a designated health care server. An encryption key and a decryption key issued by a security key issuing device are transmitted to a user terminal and the health care server by using local communication, thereby safely distributing the encryption key and the decryption key. The user terminal and the health care server encrypt and decrypt the health information of the user by using an encryption key and a decryption key and the encrypted information is transmitted through a public network such as the Internet, whereby secure communication between the user terminal and the health care server can be continuously guaranteed. Moreover, in spite of hacking of transmission of information, the information has been encrypted and personal information of the user is not included in the transmitted information by using mapping tables stored in the server, thereby guaranteeing security in information transmission.

It should be understood that the exemplary embodiments described herein should be considered in a descriptive sense only and not for purposes of limitation. Descriptions of features, advantages or aspects within each embodiment should be considered as available for other similar features, advantages or aspects in other embodiments.

What is claimed is:

1. A method of securely communicating between a user terminal and a health care server, the method comprising:
receiving an encryption key from a security key issuing device through a local communication between a user terminal and the security key issuing device;
obtaining health information of a user;
encrypting the health information by using the encryption key; and
transmitting the encrypted health information to a health care server through a network communication between the user terminal and the health care server.

2. The method of claim 1, further comprising:
receiving a decryption key from the security key issuing device through the local communication between the user terminal and the security key issuing device; and
decrypting the encrypted health information received from the health care server by using the decryption key.

3. The method of claim 2, wherein the receiving an encryption key further comprises receiving the encryption key through a local network, which directly connects the user terminal with the security key issuing device, and
the receiving a decryption key further comprises receiving the decryption key through a local network, which directly connects the user terminal with the security key issuing device.

4. The method of claim 2, wherein the receiving an encryption key further comprises receiving the encryption key by reading the encryption key from a portable storage medium, which is connected to the user terminal, and
the receiving a decryption key further comprises receiving the decryption key by reading the decryption key from a portable storage medium, which is connected to the user terminal, and
the portable storage medium, when connected to the security key issuing device, stores at least one of the encryption key and the decryption key, which are read from the security key issuing device.

5. The method of claim 2, wherein the transmitting to the health care server further comprises transmitting the encrypted health information through an internet, which is connected to the user terminal.

6. The method of claim 2, wherein the encrypting the health information further comprises encrypting the encrypted health information by using at least one of a medium access control address of the user terminal and a medium access control address of the health care server, and
the decrypting the encrypted health information further comprises decrypting the decrypted health information by using at least one of a medium access control address of the user terminal and a medium access control address of the health care server.

7. A method of securely communicating between a health care server and a user terminal, the method comprising:
receiving a decryption key from a security key issuing device through a local communication between a health care server and the security key issuing device;
receiving encrypted information through a network communication between the health care server and a user terminal; and
decrypting the encrypted information by using the decryption key.

8. The method of claim 7, further comprising:
receiving an encryption key from the security key issuing device through a local communication between the health care server and the security key issuing device; and
encrypting information to be transmitted to the user terminal by using the encryption key.

9. The method of claim 8, wherein the receiving a decryption key further comprises receiving the decryption key through a local network, which directly connects the health care server with the security key issuing device, and
the receiving an encryption key further comprises receiving the encryption key through a local network, which directly connects the health care server with the security key issuing device.

10. The method of claim 8, wherein the receiving a decryption key further comprises receiving the decryption key by reading the decryption key from a portable storage medium, which is connected to the health care server, and
the receiving an encryption key further comprises receiving the encryption key by reading the encryption key from a portable storage medium, which is connected to the health care server, and
the portable storage medium, when connected to the security key issuing device, stores at least one of the encryption key and the decryption key, which are read from the security key issuing device.

11. The method of claim 8, wherein the receiving encrypted information further comprises receiving the encrypted information through an internet, which is connected to the health care server.

12. The method of claim 8, wherein the decrypting the encrypted information further comprises decrypting the decrypted information by using at least one of a medium access control address of the user terminal and a medium access control address of the health care server, and
the encrypting information further comprises encrypting the encrypted information by using at least one of a medium access control address of the user terminal and a medium access control address of the health care server.

13. A method of securely communicating between a user terminal and a health care server, the method comprising:
transmitting an encryption key and a decryption key, which are issued by a security key issuing device to a user terminal and a health care server;
encrypting health information of a user by using the encryption key, wherein the encrypting is performed in the user terminal;
adding a unique identifier of the user to the encrypted health information;
transmitting the unique identifier to the health care server through a network communication;
decrypting the unique identifier by using the decryption key, wherein the decrypting is performed in the health care server; and
recognizing personal information of the user by using the unique identifier.

14. A computer-readable recording medium having recorded thereon a program for executing a method of any one of claims 1 on a computer.

15. A user terminal, comprising:
a health information obtaining unit, which obtains health information of a user;
a local communicating unit, which receives an encryption key through a local communication between a user terminal and a security key issuing device;
a security key obtaining unit, which obtains the encryption key;
an encrypting unit, which encrypts the health information by using the encryption key; and
a network communicating unit, which transmits the encrypted health information to a health care server through a network communication.

16. The user terminal of claim 15, wherein the local communicating unit receives a decryption key through a local communication between the user terminal and the security key issuing device, and
the security key obtaining unit obtains the decryption key.

17. The user terminal of claim 16, wherein the local communicating unit reads at least one of an encryption key and a decryption key, which are stored in a portable storage medium, and
the security key obtaining unit obtains the at least one key read by the local communicating unit.

18. The user terminal of claim 17, wherein the network communicating unit receives encrypted information from the health care server through a network communication.

19. The user terminal of claim 18, further comprising a decrypting unit decrypting the encrypted information received from the health care server by using the decryption key.

20. A health care server system comprising:
a local communicating unit, which receives a decryption key through a local communication between a health care server and a security key issuing device;
a security key obtaining unit, which obtains the decryption key;
a network communicating unit, which receives encrypted information from a user terminal through a network communication; and
a decrypting unit, which decrypts the encrypted information by using the decryption key.

21. The health care server system of claim 20, wherein the local communicating unit receives an encryption key through local communication between the health care server and the security key issuing device, and
the security key obtaining unit obtains the encryption key.

22. The health care server of claim 21, wherein the local communicating unit reads at least one of an encryption key and a decryption key, which are stored in a portable storage medium, and
the security key obtaining unit obtains the read key.

23. The health care server of claim 22, further comprising an encrypting unit encrypting information to be transmitted to a user by using the encryption key.

24. The health care server of claim 23, wherein the network communicating unit transmits the encrypted information to the user through a network communication.

25. A security key issuing device for secure communication between a user terminal and a health care server, the security key issuing device comprising:
a security key issuing unit, which issues at least one of an encryption key and a decryption key in response to a request from a healthcare service provider or a user;
a security key storage unit, which stores the encryption key and the decryption key together with user information of a user terminal; and
a security key transmitting unit, which transmits the encryption key and the decryption key to the user terminal and a health care server through a local communication.

26. The security key issuing device of claim 25, further comprising a security key recording unit recording the encryption key and the decryption key onto a portable storage medium.
